(19) United States
(12) Patent Application Publication
(10) Pub. No.: US 2013/0254099 A1
(43) Pub. Date: Sep. 26, 2013

(54) Online Method and System for an Invitation to bear witness for Union Separations

(71) Applicant: David Han, Las Vegas, NV (US)

(72) Inventor: David Han, Las Vegas, NV (US)

(21) Appl. No.: 13/430,585

(22) Filed: Mar. 26, 2012

(51) Int. Cl. G06F 15/16; G06Q 40/00

(52) U.S. Cl. 705/39; 709/204; 709/206

(57) ABSTRACT

An Invitation system of having pluralities of methods within a process for providing novel techniques to engage people to form and gather for occasions, implemented from value based Marketing and Promotional activities Digitally and non-Digitally through Wireless communications as well as within the Hypertext Transfer Protocol environment (HTTP) with robust features to bring an engaging experience. The present invention is designed to be a more affective means to communicate information to a responder that would include engaging sets of activities within each invitation process in order to yield affective ways to promote and secure attendance.

### FIELD OF THE INVENTION

The present invention relates to methods for planning and organizing a commemoration system, moreover for developing a temporary congregation through a Wireless or an Internet based network that would produce acknowledgement and yield individual admissions.

### DESCRIPTION OF THE RELATED ART

Throughout the history of digital Greetings and Invitations, there have only been methods and forms of giving and receiving in order to establish the expression of appreciation.

It would be a benefit to having a ceremonial system containing instructions for the planning of celebrations from a Wireless or a Web-based environment. It would be even a further benefit to having a secured payment system for the collection and contributions to the cost for developing a commemorative event. It would still further be a benefit to use traditional methods of gift giving such as a Registry service for the celebration in the spirit of the present invention.

### GENERAL SUMMARY OF THE INVENTION

It is thus an object of the present invention to provide a ceremonial system that will produce a method to generate participation interest through activities.

Steps of the procedures of the present invention would contain instructions to guide participation through an enrollment/admission process in order to actuate attendance of a ceremony. Each step would further include:

The first digital page includes instructions on how to participate and enroll in a celebration as well as displaying basic and relevant information pertaining to each participant.

The second digital page section may require input of participant's personal data such as the relationships between individual host/first user and what could be reflected upon the friendship or relationships each participant have with each other. This section may also include confirmation of a Gift Registry or a proprietary online digital Gift Card to be given at some point of the party, along with additional activities added to the invitation.

The additional digital pages may include the type of entertainment, photography or video capturing services, entertainment services, and food service planning to be organized during or throughout the ceremony, based on preference.

### DESCRIPTION OF THE DRAWINGS

The accompanying drawings, which is incorporated into and constitutes a part of this specification, illustrates one or more methods of the present invention and, together with the detailed description, serve to explain the principles and implementations of the invention. For a further understanding of the nature and objects of the present invention, reference should be made to the following detailed description, taken in conjunction with the accompanying drawings, in which like elements are given the same or analogous reference numbers and wherein:

FIG. 1 shows a flowchart illustrating the steps, method, application, device and apparatus for an invitation technique of the present invention, and for anyone who is skilled in the arts.

FIG. 2 identifies the structure, form, scheme and composition of the present invention once participating users have committed to the invitation for a ceremonial event, as well as a method to identify user response through promotional activities such as the recruitment of contracted agents in order to further promote the ceremonial event.

FIG. 3 is a depiction of the nuances within the celebration process that may develop throughout various activities, as a result from celebrating the occasion additional connections can be made.

### EXEMPLARY MODE FOR CARRYING OUT THE INVENTION

In many respects, the subject matter of this disclosure may be regarded as the broad scope making the disclosed technology well suited for countless applications due to its wide range of use detailed in this disclosure, and since an orderly presentation is limited to achieve. As it will be evident, many of the topical sections presented are both founded on, and foundational to, other sections.

Necessarily, then, the various sections are presented in a somewhat arbitrary order. It should be recognized that both the general principles and the particular details from each section can also be found in other sections as well. The inventor intends to explicitly teach such combinations/permutations, but practicality requires that it should also be noted that the presently-detailed technology builds on, and extends onto other technology and detailed arrangements however which the present invention should be applied. It should also be noted that the present invention is described with reference to Wireless Communications and the Internet, “on-line” activities, and “websites” by way of example, only and for the sake of convenience and clarity. As a matter of design choice, the system and method of the present invention can be readily implemented in any environment where multiple users can share content data with one another and, interact therewith through this novel system.

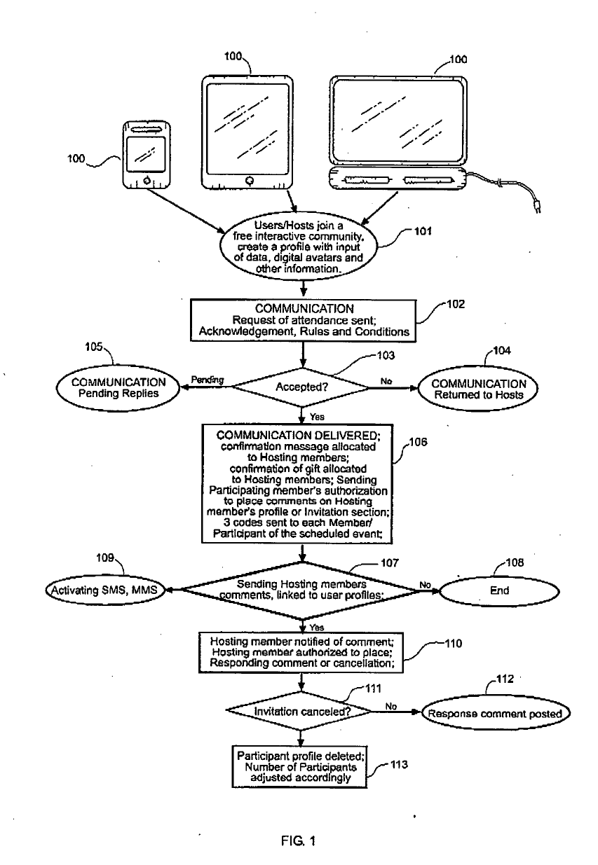

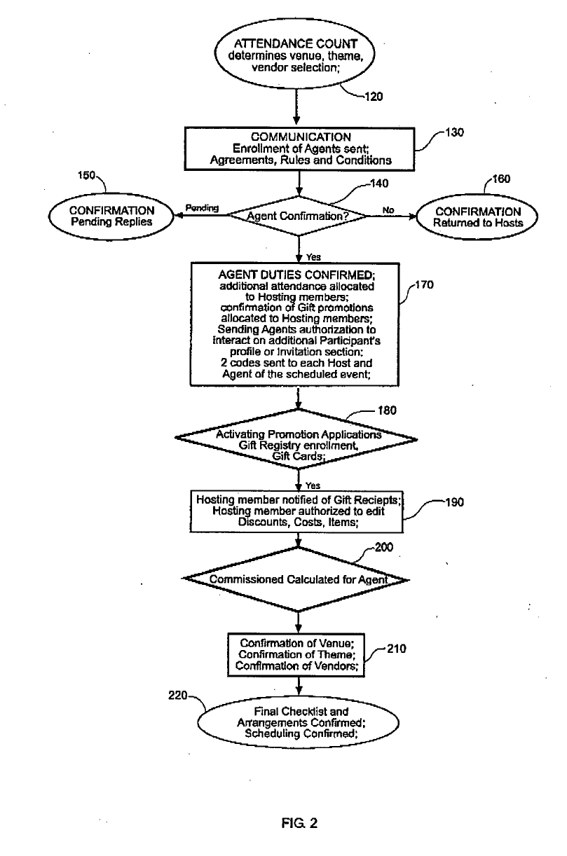

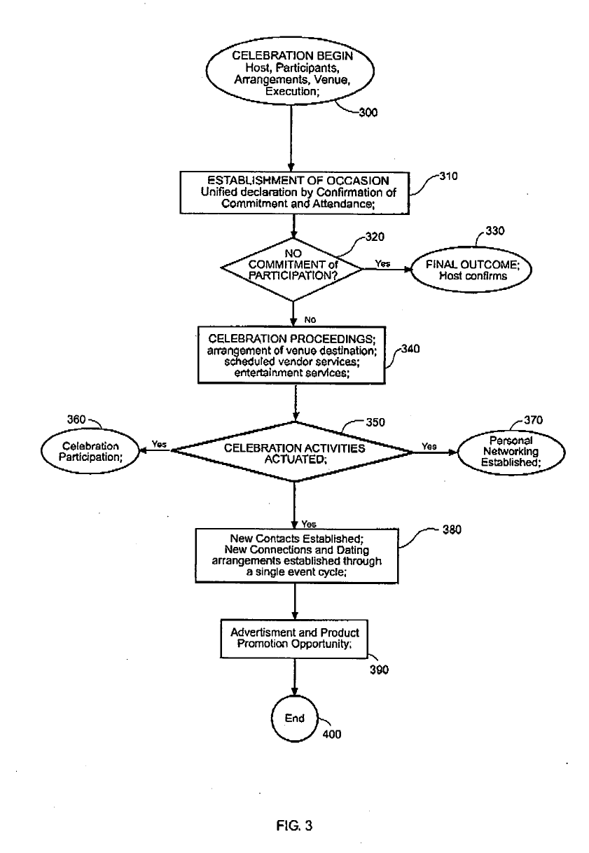

Referring now to FIG. 1, illustrating Prior Art 100 as users can engage in the embodiment through devices employing certain principles of the present invention, which can be initiated by those with ordinary skills in the arts to intuitively enroll 101 and become participants of a system architecture designed to promote participation to celebrate an occasion with rules and conditions for the attendance by way of interactive response, with possible SMS/MMS signaling 109 or other communication methods. It should be noted however, that the underlying principles of the invention are not limited to the specific architecture shown in FIG. 1, and is meant to understand that other embodiments may be altered to fit the system of the present invention, and that logical and functional, and other changes may be made without departing from the scope of the present invention in order to establish and build participation interest for the invitation. FIG. 2 depicts the landscape of the second phase of recruitment activity 130 of the invitation process. The entire cycle of one event is divided into three phases, as FIG. 2 shall be known as the second phase, which covers the value based promotional and marketing aspect. The recruitment of Agents 140 in order to further promote interest of the celebration with additional attendance 170 would also allow for compensation through a commission paid to the agent 200. The compensation is agreed upon in a contract for each of the event. FIG. 3 illustrates the celebration proceeding phase of the invitation 300 where various components of the ceremony or celebration come to formation 340. In addition the activities from participation could possibly ignite additional opportunities, for Dating encounters through a general understanding 350 since the intent of the ceremony signifies networking opportunities. As this is commonly the final phase of the celebration process, it may be considered the primary arena to exercise encounters and connections of other single participants 380. Celebrations of Occasions can be commercial in nature, thus attracting various size groups of advertisers to promote products and services at a discounted rate to further establish uniqueness of the present invention 390 from potential future or foreign competing concepts.

1-40. (canceled)

41. An Invitation System comprising:
of methods for identifying the attendance of an invitation for a celebration throughout both popular or unpopular culture, created by user entities of an Internet based content sharing system, consisting of transferred data by a wireless or computing device containing a processor, wherein the first digital content may include promotional and tag elements that identifies the individuals depicted in the digital content with a member identification field that contains data identifying all participating user entities and their unique relationships and common interest with the first user entity/invitation host(s).

42. The Invitation System of claim 41, wherein:
comprises of procedures within the invitation system and method which engages and promotes participation through marketing based values, within the digital content used.

43. The Invitation System of claim 42, wherein:
comprises of procedures within the invitation system and method which engages and promotes participation through marketing based values, within the digital content used.

44. The Invitation System of claim 43, also comprising:
character/profile identification capabilities through relational links between each member or participant in a profile associated with the first member(s) also known as the invitation host(s).

45. The Invitation System of claim 44, wherein said methods include:
a plurality of methods to develop branches of domains within the present invention, in order for any user entity participating in the invitation activity to anticipate new engagement experiences through the invitation's social values by matching personal interests/profiles with also dating participation through communication engagements.

46. The Invitation System of claim 45, wherein:
containing a data field for creation of a GIFT REGISTRY, comparable to prior art used as a WEDDING REGISTRY where its application is solely for the purpose of requesting gift items to be given to the host(s)/first users) of the invitation, which in the case of the present invention will serve to any specified occasion.

47. The Invitation System of claim 46, also comprising:
a method to sever unions through an invitation for such occasion, proposed through the present invention to a receiver, applicable to friendships, work relationships, engagements, partnerships, marriages or various sacraments, commitments and agreements.

48. The Invitation System of claim 47, further including:
a plurality of methods for promoting marketing activities for attendance through the digital invitation data field comprising of SHORT MESSAGE SERVICE (SMS), MULTIMEDIA SERVICE (MMS), Near Field Communication (NFC), and other various methods including Wireless Application Protocol (WAP) based mediums for providing responsive communications between users of the invention.

49. The Invitation System of claim 48, also comprising:
a software application with methods for securing financial contributions such as fiord raising is integrated through the present invention or a third party's proprietary application used in conjunction with the Wireless/Computerized apparatus for payment receivership with specialized fields and commands to allocate currency exchanges and transactions. Utilizing standard protocols such as an SMS banking, Electronic Funds Transfer (EFT), Electronic Money, Digital Currency or a Two-Factor Authentication method.

50. The Invitation System of claim 49, also comprising:
a system of debits and credits utilizing a Centralized method as well as a Decentralized method, which can consist of Peer-to-Peer or Merchant Banking methods to secure the exchange of currency.

51. The Invitation System of claim 50, wherein:
a system of a contractual agreements for the purpose of recruiting and securing promotional agents through the invention, with a committed duty to successfully promote an individual invitation process, with the opportunity for compensation agreed upon by the first user(s) or host(s).

52. The Invitation System of claim 51, wherein:
a data field which would fulfill the particulars of customizing event services through the skills of the arts in regards to planning, captured footage, food preparation/serving, tailored garments, customized entertainment, customized decoration, arranged travels and venue selection.

53. The Invitation System of claim 52, also comprising:
at least one method of online digital marketing either through a peer-to-peer platform, a social networking platform or any frameworks for digital devices either through traditional or new media marketing mediums such as on-line communities, chat-rooms, blogs, forums, groups, video media, clubs, and specialized websites.

54. The Invitation System of claim 53, wherein:
the present invention comprises of a broad range of use, applicable to any form of social occasions including major National or International Holidays, Baby Showers, Births, Birthdays, Graduations, Engagements, Weddings, either unique or also with less popular occasions in society such as Divorces, Deaths, Job Terminations, Tragedies, Quarrels, Resolutions and other rational reason to commemorate an occasion.

55. The Invitation System of claim 54, further including:
prior art offers a common list of occasions to determine a scheme choice based on the event selected. The present invention will consist of an unspecified field requirement to be entered by the user entity's which then, would display the occasion specified, or alternatively commemorate a National or International holiday throughout global societies. The purpose is to eliminate the requirements of choosing from a limited selection of occasions or holidays that have commonly been celebrated throughout societies and civilization, which are currently being offered by all digital Greetings, Invitation concepts, or of prior art.

56. The Invitation System of claim 55, wherein:
a data field which produces a unique marriage certificate comprising of an expiration date of the marriage agreed upon by the wedded party, to be filed for licensing with any Marital Licensing Agency throughout the world. In the spirit of the present invention's intent to develop “unique” and “untraditional” occasions, ultimately this certificate may become solutions to society's historical rise of divorces, and can become a component for societal change. The physical form of the document will also consist of a seal of approval, location, date and witness signature(s).

57. The Invitation System of claim 56, wherein:
method of forming private or personal ceremonies on a social networking platform that includes digital database storage procedures relating to the correspondence of users and entities. This method includes: a first user entity sending an invitation to additional user entities, recording in the database the additional user entity as a direct contact of the first user entity and determining that other user entities directly connected to the former user entity are indirect contacts. A unique, personal, social network forms from direct and indirect contacts and is thereby created for each user entity. Each user entity is able to control privacy settings of its data with respect to other user entities depending on the connection factor and sensitivity factor to the other entity and/their attributes.

58. The Invitation System of claim 57, wherein:
a plurality of Photographic or Video capturing mediums, fields and devices, but not limited to including computers and mobile devices, cloud based storage systems and various televised viewing apparatuses and channels such as digital, cable, and or satellite signaling networks that could control the customization of capturing, showcasing, streaming and archiving all event activities from and within the present invention.

59. The Invitation System of claim 58, further including:
customization ability of the invitation design, style and scheme to fit cultural or personal preferences which may include religion, tradition, standards, and heritage. The present invention will comprise of a default design, but also enable the user to upload photographic or graphical properties for customization.

60. The Invitation System of claim 59, wherein:
a digital page linking a first user/invitation host entity, to individual members of the invitation, displaying a particular common interest or activity, which may not be common-throughout the first user's entire social circle. This digital scheme will display an image indicator that binds each participant to the host/first user entity with his or her specified or unspecified interest.
